(19) United States
(12) Patent Application Publication
(10) Pub. No.: US 2025/0078723 A1
(43) Pub. Date: Mar. 6, 2025

(54) DISPLAY DEVICE AND DRIVER

(71) Applicants: Huizhou China Star Optoelectronics Display Co., Ltd., Huizhou, Guangdong (CN); TCL China Star Optoelectronics Technology Co., Ltd., Shenzhen (CN)

(72) Inventor: Weifeng CHEN, HuiZhou, Guangdong (CN)

(73) Assignees: Huizhou China Star Optoelectronics Display Co., Ltd., Huizhou, Guangdong (CN); TCL China Star Optoelectronics Technology Co., Ltd., Shenzhen, Guangdong (CN)

(21) Appl. No.: 18/288,836

(22) PCT Filed: Oct. 11, 2023
(86) PCT No.: PCT/CN2023/124064

§ 371 Date: Oct. 30, 2023

(30) Foreign Application Priority Data
Dec. 23, 2022 (CN) 202211664093.9

(51) Int. Cl. G09G 3/20

(52) U.S. Cl. CPC G09G 3/2096; G09G 2310/0262; G09G 2310/027; G09G 2320/041; G09G 2320/0693; G09G 2330/023

(57) ABSTRACT

The present application provides a display device and a driver. The display device includes a display panel and a driver, where the driver includes both a data signal output module and a resistance control module. The data signal output module outputs a plurality of data signals to a plurality of signal lines located in a fan-out region of the display panel. The resistance control module is electrically connected to the data signal output module and the plurality of signal lines to provide different line impedance for the plurality of data signals output by the data signal output module.

### TECHNICAL FIELD

The present application relates to the field of display technologies, and more particularly to a display device and a driver.

### BACKGROUND

Current pixel architectures of display panels mainly include one gate one data (1G1D) architecture, a Data Line Share (DLS) architecture, and a Triple Gate (Tri-gate) architecture. For the DLS architecture and the Tri-gate architecture, since the number of their source driver chips is reduced by half or more compared to the 1G1D architecture, the load driven by the source driver chips is much larger than that of the 1G1D architecture, and in particular, the load for the Tri-gate architecture is maximum. When the source driver chip is driven, charging may be undercharged due to the load being too large, and a slight difference in loads or a difference in output thrusts may result in a difference in the charging, thereby causing a difference in picture quality. However, types of different fan-out regions cannot be compensated for by controlling the data output by the source driver chip, as shown in FIG. 1.

### SUMMARY

Embodiments of the present application provides a display device and a driver, which can improve a problem of split screen display due to the difference in the charging.

An embodiment of the present application provides a display device, including a display panel and a driver. The display panel includes a fan-out region and a plurality of signal lines located in the fan-out region. The driver includes a data signal output module and a resistance control module, where the resistance control module is electrically connected to the plurality of signal lines and the data signal output module. The data signal output module is configured to output a plurality of data signals to the plurality of signal lines, and the resistance control module is configured to provide different line impedance for the plurality of data signals output by the data signal output module.

The present application further provides a driver for driving a display panel, where the display panel includes a fan-out region and a plurality of signal lines located in the fan-out region, and the driver includes a data signal output module and a resistance control module. The resistance control module is electrically connected to the plurality of signal lines and the data signal output module. The data signal output module is configured to output a plurality of data signals to the plurality of signal lines, and the resistance control module is configured to provide different line impedance for the plurality of data signals output by the data signal output module.

### Beneficial Effects

Compared with the related art, the present application provides a display device and a driver. The display device includes a display panel and a driver. The driver includes a data signal output module and a resistance control module, and the data signal output module is configured to output a plurality of data signals to a plurality of signal lines located in a fan-out region of the display panel. By enabling the resistance control module to be electrically connected to the data signal output module and the plurality of signal lines, different line impedance are provided for the plurality of data signals output by the data signal output module, so that the time when the plurality of data signals output by the data signal output module pass through the resistance control module and are transmitted to the plurality of signal lines in the fan-out region of the display panel tends to be consistent, thereby improving the difference in the charging, improving the difference in the picture quality due to uneven charging caused by the difference in the load or the difference in the output thrusts, and improving the display effect of the display panel.

### BRIEF DESCRIPTION OF THE DRAWINGS

FIG. 1 is impedance corresponding to a plurality of data signals output from a data signal output module when the plurality of data signals are transmitted to a plurality of signal lines in a display panel in the related art.

FIGS. 2A-2B are schematic structural diagrams of a display device according to some embodiments of the present application.

FIG. 3 is a schematic structural diagram of a resistance control module according to some embodiments of the present application.

FIG. 4 is an output characteristic curve of a first transistor according to some embodiments of the present application.

FIG. 5 is a schematic diagram of a driver according to some embodiments of the present application.

### DETAILED DESCRIPTION

To make the objectives, technical solutions, and effects of the present application more clear and definite, the present application is illustrated in detail below by referring to the accompanying drawings and illustrating the embodiments. It should be understood that the specific embodiments described here are only used to explain the present application, and are not used to limit the present application.

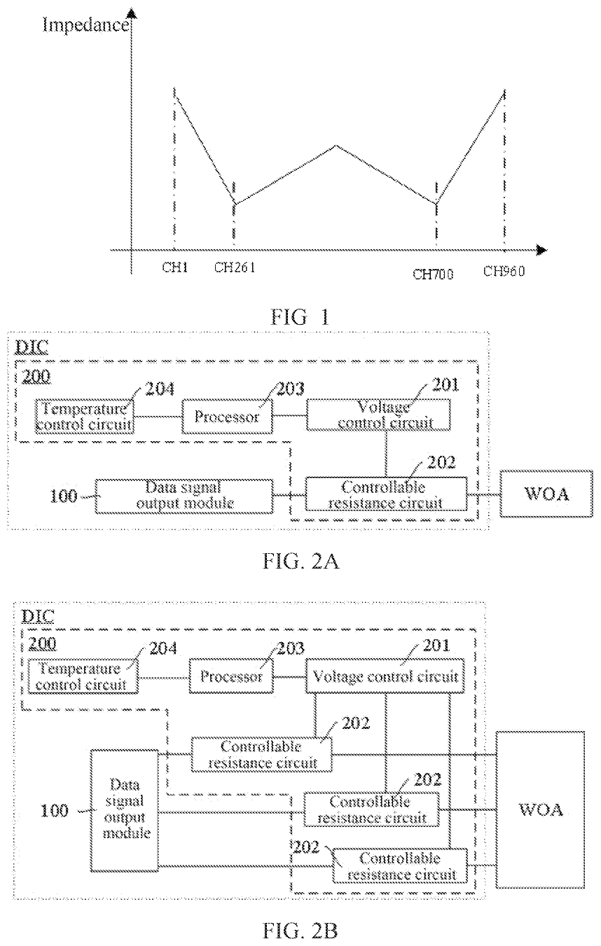

Specifically, FIG. 1 is impedance corresponding to a plurality of data signals output from a data signal output module when the plurality of data signals are transmitted to a plurality of signal lines in a display panel in the related art. As can be seen from FIG. 1 that, when the plurality of data signals are transmitted to the plurality of signal lines in the fan-out region of the display panel via respective output ports (for example, CH1-CH960), the respective impedance corresponding to the respective data signals are different. Therefore, the time when the plurality of data signals are transmitted to the plurality of signal lines in the fan-out region of the display panel cannot be kept consistent, thereby causing a difference in the charging, which in turn causes a difference in the displayed picture quality of the display panel.

FIGS. 2A-2B are schematic structural diagrams of a display device according to some embodiments of the present application. An embodiment of the present application provides a display device, including a display panel and a driver DIC.

Alternatively, the display panel includes a passive light emitting display panel (such as a liquid crystal display panel, a quantum dot display panel, or the like), a self-luminous light emitting display panel (such as an organic light emitting diode display panel, a sub-millimeter light emitting diode display panel, a micro light emitting diode display panel, or the like), or the like.

It should be understood that the display device includes a movable display device (such as a notebook computer, a mobile phone, and the like), a fixed terminal (such as a desktop computer, a television, and the like), a measuring device (such as a sports wristband, a thermometer, and the like), and the like.

The display panel includes a fan-out region WOA and a plurality of signal lines located within the fan-out region WOA. Alternatively, the plurality of signal lines are configured to transmit a plurality of data signals.

The driver DIC is electrically connected to the display panel, and includes a data signal output module 100 and a resistance control module 200.

The data signal output module 100 is configured to output the plurality of data signals to the plurality of signal lines. Alternatively, the data signal output module 100 has a plurality of output ports electrically connected to the plurality of signal lines. Alternatively, the plurality of output ports are electrically connected in one-to-one correspondence with the plurality of signal lines. Alternatively, the data signal output module 100 includes an output buffer.

The resistance control module 200 is electrically connected to the plurality of signal lines and the data signal output module 100 and configured to provide different line impedance for the plurality of data signals output by the data signal output module 100.

In the display device, by enabling the resistance control module 200 to provide different line impedance for the plurality of data signals output by the data signal output module 100, the time when the plurality of data signals output by the data signal output module 100 pass through the resistance control module 200 and are transmitted to the plurality of signal lines in the fan-out region WOA of the display panel tends to be consistent, thereby improving the difference in the charging, improving the difference in the picture quality, such as screen splitting, due to uneven charging caused by the difference in the load or the difference in the output thrusts, and improving the display effect of the display panel. Furthermore, it is also suitable for compensating for difference in the outputs of different fan-out regions WOA, and has high compatibility.

Alternatively, still referring to FIGS. 2A-2B, the resistance control module 200 includes a voltage control circuit 201 and at least one controllable resistance circuit 202. The voltage control circuit 201 is configured to output at least one first voltage signal V₁. The at least one controllable resistance circuit 202 is electrically connected to the voltage control circuit 201, the data signal output module 100, and the respective signal lines, and is configured to provide the line impedance according to the respective first voltage signal V₁.

That is, the resistance control module 200 may include the controllable resistance circuit 202. The controllable resistance circuit 202 is electrically connected to the voltage control circuit 201, the data signal output module 100, and the plurality of signal lines so as to provide the line impedance according to the first voltage signal V₁, so that the time when the plurality of data signals output by the data signal output module 100 pass through the resistance control module 200 and are transmitted to the plurality of signal lines in the fan-out region WOA of the display panel tends to be consistent, thereby improving the difference in the picture quality, such as screen splitting, due to the difference in the charging, and improving the display effect of the display panel.

Since the data signal output module 100 outputs the plurality of data signals and the line impedance corresponding to the plurality of data signals may be different with each other, more accurate line impedance are matched for the plurality of data signals output by the data signal output module 100. The resistance control module 200 may include a plurality of controllable resistance circuits 202.

Alternatively, the resistance control module 200 includes a plurality of controllable resistance circuits 202, where each of the controllable resistance circuits 202 is electrically connected between one of the output ports and corresponding one of the signal lines to match one line impedance for each of the data signals so as to provide accurate line impedance for the plurality of data signals output by the data signal output module 100, which in turn enables the time when the plurality of data signals output pass through the resistance control module 200 and are transmitted to the plurality of signal lines in the fan-out region WOA of the display panel to tend to be consistent, thereby improving the difference in the picture quality, such as screen splitting, due to the difference in the charging, and improving the display effect of the display panel.

Alternatively, to reduce power consumption and manufacturing costs while improving the difference in the picture quality due to the difference in the charging, the plurality of output ports of the data signal output module 100 may be divided. Accordingly, the resistance control module 200 includes a plurality of controllable resistance circuits 202, where each of the controllable resistance circuits 202 is electrically connected between a plurality of consecutive output ports and a plurality of respective signal lines to match one line impedance for the plurality of data signals output via the plurality of consecutive output ports, so that the time when the plurality of data signals output pass through the resistance control module 200 and are transmitted to the plurality of signal lines in the fan-out region WOA of the display panel tends to be consistent, thereby improving the difference in the picture quality, such as screen splitting, due to the difference in the charging, and improving the display effect of the display panel.

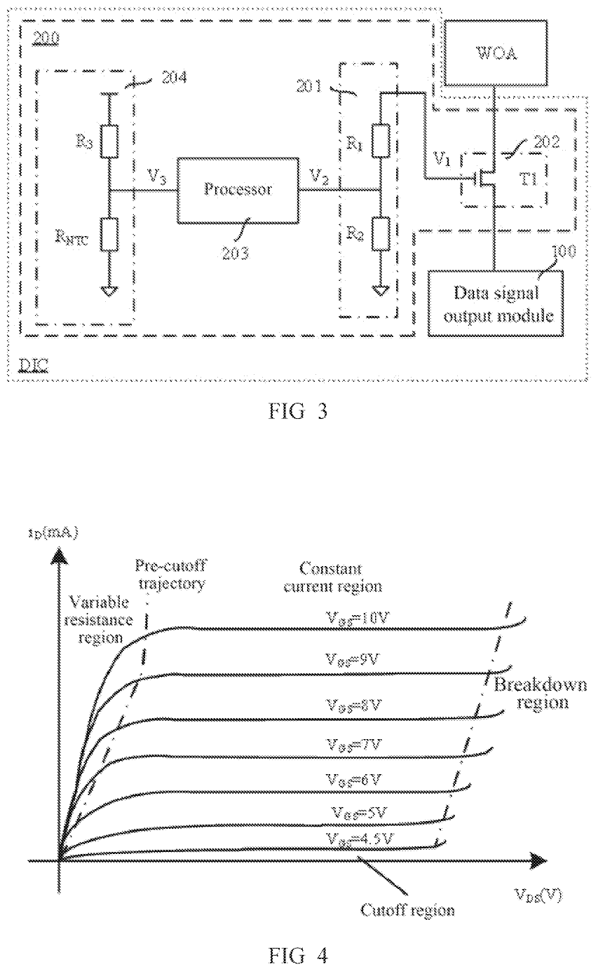

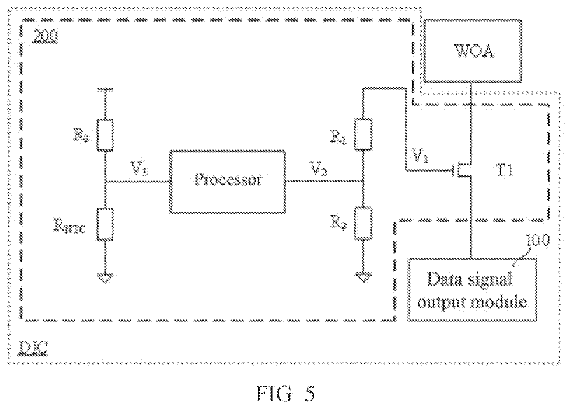

FIG. 3 is a schematic structural diagram of a resistance control module 200 according to some embodiments of the present application, and FIG. 4 is an output characteristic curve of a first transistor according to some embodiments of the present application. Alternatively, the controllable resistance circuit 202 includes a first transistor T1, where a control terminal of the first transistor T1 is electrically connected to the voltage control circuit 201, and an input terminal and an output terminal of the first transistor T1 are connected in series between the data signal output module 100 and the plurality of signal lines. The first transistor T1 is configured to operate in a variable resistance region according to the respective first voltage signal V₁ to achieve the effect of controllable and adjustable resistance.

Alternatively, the resistance control module 200 further includes a processor 203 electrically connected to the voltage control circuit 201 and configured to output a second voltage signal V₂ to the voltage control circuit 201 so that the voltage control circuit 201 generates the first voltage signal V₁ according to the second voltage signal V₂.

Alternatively, the voltage control circuit 201 includes a first resistor R₁ and a second resistor R₂. The first resistor R₁ is connected in series between the control terminal of the first transistor T1 and the processor 203, and the second resistor R₂ is connected in series between the processor 203 and a first voltage terminal. The processor 203 is configured to transmit the second voltage signal V₂ to an electrical junction between the first resistor R₁ and the second resistor R₂ so that the magnitude of the first voltage signal V₁ is controlled by the second voltage signal V₂ output by the processor 203. That is, the first voltage signal V₁ is V₁=V₂*(R₁+R₂)/R₂.

In addition, since a resistance-capacitance delay may vary with temperature, the display device has a different performance of charging difference at different temperatures. Therefore, the resistance control module 200 further includes a temperature control compensation circuit in order to improve the difference in the picture quality, such as screen splitting, due to the difference in the charging caused by change of the resistance-capacitance delay with the temperature. The temperature control compensation circuit is electrically connected to the voltage control circuit 201 and configured to generate the second voltage signal V₂ according to an ambient temperature to output the generated second voltage signal V₂ to the voltage control circuit 201.

Alternatively, the temperature control compensation circuit includes the processor 203 and a temperature control circuit 204 electrically connected to the processor 203. The temperature control circuit 204 is configured to generate a third voltage signal V₃ according to the ambient temperature, and the processor 203 is configured to generate the second voltage signal V₂ according to the third voltage signal V₃.

Alternatively, the processor 203 includes a storage unit and a processing unit. The storage unit is configured to store a mapping relationship between the ambient temperature and a voltage signal, and the processing unit is configured to output the second voltage signal V₂ according to the third voltage signal V₃ and the mapping relationship.

Alternatively, the processor 203 includes a programmable logic gate array or the like.

Alternatively, the temperature control circuit 204 includes a third resistor R₃ and a thermistor R_{NTC}. The third resistor R₃ is connected in series between the processor 203 and a second voltage terminal VDD, and the thermistor R_{NTC} is connected in series between the processor 203 and a third voltage terminal. The processor 203 is configured to receive the third voltage signal V3 at an electrical junction between the third resistor R₃ and the thermistor R_{NTC}.

The third voltage signal V₃ is V₃=VDD*R_{NTC}/(R₃+R_{NTC}). R_{NTC}=R_{N}*e^{B*(1/T-1/TN)}, where R_{N} represents a resistance value of the thermistor at the rated temperature T_{N}(K), B represents a thermistor index, and T represents the current ambient temperature. Therefore, there is a one-to-one correspondence between the ambient temperature and the thermistor R_{NTC}. The ambient temperature can be converted into the third voltage signal V₃ in a manner of voltage division, and then the ambient temperature can be reduced by processing the third voltage signal V₃ with the processor 203, so that the second voltage signal V₂ corresponding to the ambient temperature is obtained by the mapping relation, so as to control the first voltage signal V₁ output by the voltage control circuit 201 with the second voltage signal V₂.

FIG. 5 is a schematic diagram of a driver DIC according to some embodiments of the present application. The present application further provides a driver DIC for driving a display panel, where the display panel includes a fan-out region WOA and a plurality of signal lines located in the fan-out region WOA, and the driver DIC includes a data signal output module 100 and a resistance control module 200. The resistance control module 200 is electrically connected to the plurality of signal lines and the data signal output module 100. The data signal output module 100 is configured to output a plurality of data signals to the plurality of signal lines, and the resistance control module 200 is configured to provide different line impedance for the plurality of data signals output by the data signal output module 100.

Alternatively, the resistance control module 200 includes a first transistor T1, a first resistor R₁, a second resistor R₂, a third resistor R₃, a thermistor R_{NTC}, and a processor.

A control terminal of the first transistor T1 is electrically connected to the voltage control circuit 201, and an input terminal and an output terminal of the first transistor T1 are connected in series between the data signal output module 100 and the plurality of signal lines.

The first resistor R₁ is connected in series between the control terminal of the first transistor T1 and the processor, and the second resistor R₂ is connected in series between the processor and a first voltage terminal. The third resistor R₃ is connected in series between the processor 203 and a second voltage terminal VDD, and the thermistor R_{NTC} is connected in series between the processor and a third voltage terminal.

Since there is a one-to-one correspondence between the ambient temperature and the thermistor R_{NTC}, the ambient temperature can be converted into the third voltage signal V₃ in a manner that the third resistor R₃ and the thermistor R_{NTC} are connected in series for voltage division, and then the second voltage signal V₂ corresponding to the ambient temperature can be obtained by processing the third voltage signal V₃ with the processor, and the magnitude of the first voltage signal V₁ can be controlled with the second voltage signal V₂ in a manner that the first resistor R₁ and the second resistor R₂ are connected in series for voltage division. As a result, the first transistor T₁ operates in the variable resistance region under the control of the first voltage signal V₁ to realize the effect of controllable and adjustable resistance, which in turn provides different line impedance for the plurality of data signals output from the data signal output module 100.

A specific example is used herein to describe a principle and an implementation of the present application. The description of the foregoing embodiments is merely used to help understand a method and a core idea of the present application. In addition, a person skilled in the art may make changes in a specific implementation manner and an application scope according to an idea of the present application. In conclusion, content of this specification should not be construed as a limitation on the present application.

What is claimed is:

1. A display device, comprising:
a display panel including both a fan-out region and a plurality of signal lines located within the fan-out region; and
a driver including both a data signal output module and a resistance control module, wherein the resistance control module is electrically connected to the plurality of signal lines and the data signal output module, the data signal output module is configured to output a plurality of data signals to the plurality of signal lines, and the resistance control module is configured to provide different line impedance for the plurality of data signals output by the data signal output module.

2. The display device of claim 1, wherein the resistance control module comprises:
a voltage control circuit configured to output at least one first voltage signal; and
at least one controllable resistance circuit electrically connected to all of the voltage control circuit, the data signal output module, and the respective signal lines and configured to provide the line impedance based on the respective first voltage signal.

3. The display device of claim 2, wherein the resistance control module further comprises:
a temperature control compensation circuit electrically connected to the voltage control circuit and configured to generate a second voltage signal based on an ambient temperature to output the generated second voltage signal to the voltage control circuit.

4. The display device of claim 3, wherein
the temperature control compensation circuit comprises: a processor and a temperature control circuit electrically connected to the processor, wherein the temperature control circuit is configured to generate a third voltage signal based on the ambient temperature, and the processor is configured to generate the second voltage signal based on the third voltage signal.

5. The display device of claim 4, wherein the processor comprises:
a storage unit configured to store a mapping relationship between the ambient temperature and a voltage signal; and
a processing unit configured to output the second voltage signal based on the third voltage signal and the mapping relationship.

6. The display device of claim 4, wherein the controllable resistance circuit comprises:
a first transistor, wherein a control terminal of the first transistor is electrically connected to the voltage control circuit, and both an input terminal and an output terminal of the first transistor are connected in series between the data signal output module and the plurality of signal lines;
wherein the first transistor is configured to operate in a variable resistance region based on the respective first voltage signal.

7. The display device of claim 6, wherein the voltage control circuit comprises:
a first resistor connected in series between the control terminal of the first transistor and the processor; and
a second resistor connected in series between the processor and a first voltage terminal;
wherein the processor is configured to transmit the second voltage signal to an electrical junction between the first resistor and the second resistor.

8. The display device of claim 4, wherein the temperature control circuit comprises:
a third resistor connected in series between the processor and a second voltage terminal; and
a thermistor connected in series between the processor and a third voltage terminal;
wherein the processor is configured to receive the third voltage signal at an electrical junction between the third resistor and the thermistor.

9. The display device of claim 2, wherein,
the data signal output module includes a plurality of output ports electrically connected to the plurality of signal lines; and
the resistance control module includes a plurality of the controllable resistance circuits, wherein each of the controllable resistance circuits is electrically connected between a plurality of consecutive ones of the output ports and a plurality of respective ones of the signal lines.

10. A driver for driving a display panel, the display panel including both a fan-out region and a plurality of signal lines located in the fan-out region, wherein the driver comprises:
a data signal output module and a resistance control module, wherein the resistance control module is electrically connected to the plurality of signal lines and the data signal output module, the data signal output module is configured to output a plurality of data signals to the plurality of signal lines, and the resistance control module is configured to provide different line impedance for the plurality of data signals output by the data signal output module.

11. The driver of claim 10, wherein the resistance control module comprises:
a voltage control circuit configured to output at least one first voltage signal; and
at least one controllable resistance circuit electrically connected to all of the voltage control circuit, the data signal output module, and the respective signal lines and configured to provide the line impedance based on the respective first voltage signal.

12. The driver of claim 11, wherein the resistance control module further comprises:
a temperature control compensation circuit electrically connected to the voltage control circuit and configured to generate a second voltage signal based on an ambient temperature to output the generated second voltage signal to the voltage control circuit.

13. The driver of claim 12, wherein
the temperature control compensation circuit comprises: a processor and a temperature control circuit electrically connected to the processor, wherein the temperature control circuit is configured to generate a third voltage signal based on the ambient temperature, and the processor is configured to generate the second voltage signal based on the third voltage signal.

14. The driver of claim 13, wherein the processor comprises:
a storage unit configured to store a mapping relationship between the ambient temperature and a voltage signal; and
a processing unit configured to output the second voltage signal based on the third voltage signal and the mapping relationship.

15. The driver of claim 13, wherein the controllable resistance circuit comprises:
a first transistor, wherein a control terminal of the first transistor is electrically connected to the voltage control circuit, and both an input terminal and an output terminal of the first transistor are connected in series between the data signal output module and the plurality of signal lines;
wherein the first transistor is configured to operate in a variable resistance region based on the respective first voltage signal.

16. The driver of claim 15, wherein the voltage control circuit comprises:
a first resistor connected in series between the control terminal of the first transistor and the processor; and
a second resistor connected in series between the processor and a first voltage terminal;
wherein the processor is configured to transmit the second voltage signal to an electrical junction between the first resistor and the second resistor.

17. The driver of claim 13, wherein the temperature control circuit comprises:
a third resistor connected in series between the processor and a second voltage terminal; and
a thermistor connected in series between the processor and a third voltage terminal;
wherein the processor is configured to receive the third voltage signal at an electrical junction between the third resistor and the thermistor.

18. The driver of claim 11, wherein,
the data signal output module includes a plurality of output ports electrically connected to the plurality of signal lines; and
the resistance control module includes a plurality of the controllable resistance circuits, wherein each of the controllable resistance circuits is electrically connected between a plurality of consecutive ones of the output ports and a plurality of respective ones of the signal lines.
